(19) United States
(12) Patent Application Publication
(10) Pub. No.: US 2020/0158244 A1
(43) Pub. Date: May 21, 2020

(54) Seal Assembly and Sealing Structure for Triple-Eccentric Hard Sealing Butterfly Valve and Triple-Eccentric Hard Sealing Butterfly Valve

(71) Applicant: Mao-Teng Sun, Shanghai (CN)

(72) Inventor: Mao-Teng Sun, Shanghai (CN)

(21) Appl. No.: 16/543,521

(22) Filed: Aug. 17, 2019

(30) Foreign Application Priority Data
Nov. 19, 2018 (CN) 2018113777435

(51) Int. Cl. F16K 1/226

(52) U.S. Cl. CPC F16K 1/2263

(57) ABSTRACT

The present invention discloses a sealing assembly for a triple-eccentric metal hard sealing butterfly valve, comprising at least two metal sheets and at least two sealing rings made of a non-metal auxiliary material, wherein an annular groove is provided on one surface of each metal sheet, and each sealing ring is embedded in the corresponding annular groove. The present invention also discloses a sealing structure comprising the sealing assembly and a triple-eccentric hard sealing butterfly valve comprising the sealing structure. The present invention improves the reliability of the sealing and is completely sealed by the metal. The application of the sealing assembly according to the present invention enables the application range of the triple-eccentric butterfly valve to be extended to any medium, having high temperature, low temperature and severe working conditions, and extending the service life of the triple-eccentric sealing significantly.

### TECHNICAL FIELD

The present invention relates to the technical field of a triple-eccentric metal hard sealing butterfly valve, in particular to a sealing assembly and a sealing structure for a triple-eccentric metal hard sealing butterfly valve and a triple-eccentric hard sealing butterfly valve.

### BACKGROUND

Butterfly valves form a large category of valves, which play the role of truncation, throttling and flow regulation on medium conveying pipelines in urban construction, environmental protection, water conservancy, electric power, pharmaceutical, petroleum, chemical engineering, natural gas, nuclear power, maritime work, aerospace and other industries.

The triple-eccentric hard sealing butterfly valve is gradually evolved from a midline butterfly valve and a double-eccentric butterfly valve. Referring to FIG. 1 to FIG. 3, the conventional triple-eccentric hard sealing butterfly valve is mainly consisted of a valve body 1, a valve plate 2, a valve stein 3, a valve plate sealing assembly 4, and a valve body sealing surface 5.

The triple-eccentric hard sealing butterfly valve is a partial rotary valve system. The switching process is as follows: when the valve stein 3 rotates clockwise to 0° to 90°, the valve position is closed, and when the valve stein 3 rotates counterclockwise 90° to 0°, the valve position is opened. The so-called triple eccentricity as shown in FIG. 4 refers to the addition of an angular eccentricity on the basis of the double-eccentric structure, that is to say, the sealing surface of the butterfly valve is obliquely tapered. The structure is characterized in that the outer peripheral surface of the valve plate sealing assembly 4 is processed into an outer obliquely tapered surface, and the valve body sealing surface 5 is processed into an inner inclined tapered surface. At this time, the sealing surface of the butterfly valve becomes elliptical, and the shape of the sealing surface of the butterfly valve is also asymmetrical in the upper and lower parts. Since the sealing surface of the butterfly valve is obliquely tapered, the valve plate at one side which is divided into a large one by the valve stein is pressed upward toward the valve body along a large oblique curved surface, and the valve plate at one side which is divided into a small one is pressed downward toward a first valve along a small oblique curved surface. The sealing between the valve plate sealing assembly 4 and the valve body sealing surface 5 does not depend on elastic deformation of the valve plate sealing assembly 4, but completely depends on the compression of the contact surface between the valve plate sealing assembly 4 and the valve body sealing surface 5. Therefore, the opening and closing of the triple-eccentric butterfly valve is basically frictionless, and the valve is closed more tightly and tightly as the closing pressure increases.

With the development of modern industry, the application range of the triple-eccentric hard sealing butterfly valve has been expanding. The sealing assembly of a conventional triple-eccentric hard-seal butterfly valve cannot meet the requirements of the piping system, such as the structure shown in FIGS. 5 and 6, for the following reasons.

The sealing assembly 4 of a conventional triple-eccentric metal hard sealing butterfly valve is consisted of three metal sheets 10, 20, 30 and non-metal auxiliary materials 40, 50 as shown in FIGS. 5 and 6, the non-metal auxiliary material 40 is provided between the metal sheet 10 and the metal sheet 20, and the non-metallic auxiliary material 50 is provided between the metal sheet 20 and the metal sheet 30. Such a structure has the following problems.

1. The metal sheets 10, 20, 30 are partitioned by the non-metallic auxiliary materials 40, 50, so that the frictional forces between the metal sheets 10, 20, 30 are increased.

2. The end faces of the metal sheets 10, 20, 30 are in contact with the sealing surface 5 of the valve body with the interposed metal auxiliary materials 40, 50, which directly act on the sealing surface 5, which helps the triple-eccentric hard sealing butterfly valves to play the assisting role of sealing performance at the factory test. According to the triple-eccentric characteristic described in the above FIG. 4, during the initial process of opening and closing the triple-eccentric hard sealing butterfly valve, the metal sheets 10, 20, 30 and the sealing surface 5 form a forced friction (see FIG. 18), so that a radial series motion is generated between the metal sheets, which causes the metal auxiliary materials 40 and 50 interposed between the metal sheets to fall off due to low strength, affecting the sealing performance of the butterfly valve, and being inconsistent with the name of the triple-eccentric metal hard sealing butterfly valve. When the valve position is opened (see FIG. 19), the metal auxiliary materials 40, 50 interposed between the metal sheets are washed by the medium in the pipeline, which also causes the falling off and affects the reliability of the sealing. In addition, after the non-metal auxiliary materials 40, 50 fall off, there must be a gap or a slit in the sealing surface between the sealing assembly 4 and the valve body sealing surface 5, and it is easy for the impurities in the pipeline medium to fill the gap and the slit to cause damage to the sealing assembly, thereby reducing the life.

The existing sealing initially plays the role of sealing performance. Later, due to the serial motion between the metal sheets, the graphite will be squeezed out between the metal sheets, so that the sealing performance is extremely weakened during use, which seriously affects the sealing life so as to result in the so-called triple-eccentric metal hard sealing butterfly valve. In fact, it plays the role of sealing by filling a graphite sheet, and the metal hard sealing is unworthy of its name.

### SUMMARY

One of the technical problems to be solved by the present invention is to provide a sealing assembly for a triple-eccentric metal hard-tight butterfly valve for the deficiencies of the valve plate sealing assembly used in a conventional triple-eccentric metal hard sealing butterfly valve. The sealing assembly can realize the sealing of the triple-eccentric butterfly valve and complete contact between the metals, and can be reliably sealed, so that the application of the butterfly valve is more extensive, such as high temperature, high pressure and other more severe working conditions, and the service life is longer.

The second technical problem to be solved by the present invention is to provide a sealing structure comprising the above sealing assembly.

The third technical problem to be solved by the present invention is to provide a triple-eccentric hard sealing butterfly valve comprising the above sealing structure.

A sealing assembly for a triple-eccentric metal hard sealing butterfly valve according to a first aspect of the present invention comprises at least two metal sheets and at least two sealing rings made of a non-metallic auxiliary material, wherein an annular groove is provided on one surface of each metal sheet, and each sealing ring is embedded in the corresponding annular groove.

In a preferred embodiment of the present invention, the metal sheets are superposed together in an axial direction of the metal sheets, and a sealing contact is formed between an outer surface of the sealing ring and the surface of the adjacent metal sheet on which an annular groove is not provided.

In a preferred embodiment of the present invention, the sealing groove is provided on a side of the metal sheet away from an outer peripheral surface of the metal sheet.

In a preferred embodiment of the present invention, the outer peripheral surface of the metal sheet is processed into a slope to form a hard sealing surface of the sealing assembly.

In a preferred embodiment of the present invention, the non-metallic auxiliary material is graphite and a graphite article.

A sealing structure comprising the sealing assembly according to a second aspect of the present invention further comprises another hard sealing surface that is sealed in cooperation with a hard sealing surface of the sealing assembly; wherein the sealing assembly is provided on a valve plate of the triple-eccentric butterfly valve, and the other hard sealing surface is provided on a valve body of the triple-eccentric butterfly valve.

In a preferred embodiment of the present invention, the hard sealing surface is processed into an outer obliquely tapered surface and the other hard sealing surface is processed into an inner obliquely tapered surface.

A sealing structure comprising the sealing assembly according to the second aspect of the present invention further comprises another hard sealing surface that is sealed in cooperation with a hard sealing surface of the sealing assembly; wherein the sealing assembly is provided on the valve body of the triple-eccentric butterfly valve, and the other hard sealing surface is provided on the valve plate of the triple-eccentric butterfly valve.

In a preferred embodiment of the present invention, the hard sealing surface is processed into an inner obliquely tapered surface and the other hard sealing surface is processed into an outer obliquely tapered surface.

A sealing structure comprising the sealing assembly according to the second aspect of the present invention comprises the above two sets of sealing assemblies, wherein one set of sealing assemblies is provided on the valve body of the triple-eccentric butterfly valve, and the other set of sealing assemblies is provided on the valve plate of the triple-eccentric butterfly valve; the hard sealing surfaces of the two sets of seal assemblies are in sealing contact.

In a preferred embodiment of the present invention, the hard sealing surface provided in the sealing assembly on the valve plate of the triple-eccentric butterfly valve is processed into an outer obliquely tapered surface, and the hard sealing surface provided in the sealing assembly on the valve body of the triple-eccentric butterfly valve is processed into an inner obliquely tapered surface.

A triple-eccentric hard sealing butterfly valve according to a third aspect of the present invention comprises the above sealing structure.

In a preferred embodiment of the present invention, the triple-eccentric hard sealing butterfly valve is a double-clip-type triple-eccentric hard sealing butterfly valve, a flange-type triple-eccentric hard sealing butterfly valve, a boss-type triple-eccentric hard sealing butterfly valve, a lug-type triple-eccentric hard sealing butterfly valve or a welding-type triple-eccentric hard sealing butterfly valve.

Since the above technical solution is adopted, the present invention adopts a new structure of a sealing assembly formed by processing an annular groove on a metal sheet and placing a sealing ring processed by the non-metal sealing auxiliary material in the annular groove, which has the following beneficial effects when compared with the prior art.

1. The present invention adopts a new structure of a sealing assembly formed by processing an annular groove on a metal sheet and placing a sealing ring processed by the non-metal sealing auxiliary material in the annular groove. When the triple-eccentric butterfly valve is under the action of the opening and closing force, the friction between a plurality of metal sheets will be reduced, so that there is a slight amount of serial motion between the metal sheets, so that the hard sealing surface of the sealing assembly is more likely to abut against the other hard sealing surface (the valve body sealing surface), thereby improving the sealing fit, truly forming a complete contact between metals for sealing, and making the sealing performance more reliable.

2. The present invention adopts a new structure of a sealing assembly formed by processing an annular groove on a metal sheet and placing a sealing ring processed by the non-metal sealing auxiliary material in the annular groove. When the valve position is opened, the medium in the pipeline will not wash the sealing ring made of non-metallic auxiliary materials under the action of the flow rate, and will not make the non-metallic auxiliary materials fall off so as to directly affect the reliability of the sealing. A gap or a slit will not be formed in the hard sealing surface due to the non-metallic auxiliary materials falling off, so that it is easy for the impurities in the pipeline medium to fill the gap and the slit to cause damage to the sealing assembly, thereby improving the life.

3. The present invention improves the reliability of the sealing and is completely sealed by the metal. The application of the sealing assembly according to the present invention enables the application range of the triple-eccentric butterfly valve to be extended to any medium, having high temperature, low temperature and severe working conditions, and extending the service life of the triple-eccentric sealing significantly.

### BRIEF DESCRIPTION OF THE DRAWINGS

FIG. 1 is a schematic view illustrating the structure of a conventional triple-eccentric hard sealing butterfly valve.

FIG. 2 is a schematic view illustrating the cross-section of a conventional triple-eccentric hard sealing butterfly valve.

FIG. 3 is an enlarged schematic view at A of FIG. 2;

FIG. 4 is a schematic view illustrating the sealing principle of a conventional triple-eccentric hard sealing butterfly valve.

FIG. 5 is a schematic view illustrating the structure of a valve plate sealing assembly of a conventional triple-eccentric metal hard sealing butterfly valve.

FIG. 6 is an enlarged schematic view at A of FIG. 5.

FIG. 7 is a schematic view illustrating the structure of a sealing assembly according to the present invention.

FIG. 8 is an enlarged schematic view at A of FIG. 7.

FIG. 9 is a schematic view illustrating the structure of a triple-eccentric hard sealing butterfly valve according to the present invention.

FIG. 10 is a schematic view illustrating the cross-section of a triple-eccentric hard sealing butterfly valve according to the present invention.

FIG. 11 is an enlarged schematic view at A of FIG. 10.

FIG. 12 is a schematic view illustrating the structure of another triple-eccentric hard sealing butterfly valve according to the present invention.

FIG. 13 is a schematic view illustrating the cross-section of another triple-eccentric hard sealing butterfly valve according to the present invention.

FIG. 14 is an enlarged schematic view at A of FIG. 13.

FIG. 15 is a schematic view illustrating the structure of a still another triple-eccentric hard sealing butterfly valve according to the present invention.

FIG. 16 is a schematic view illustrating the cross-section of still another triple-eccentric hard sealing butterfly valve according to the present invention.

FIG. 17 is an enlarged schematic view at A of FIG. 16.

FIG. 18 is a schematic view illustrating the conventional triple-eccentric hard sealing butterfly valve in a closed state.

FIG. 19 is a schematic view illustrating the conventional triple-eccentric hard sealing butterfly valve in an open state.

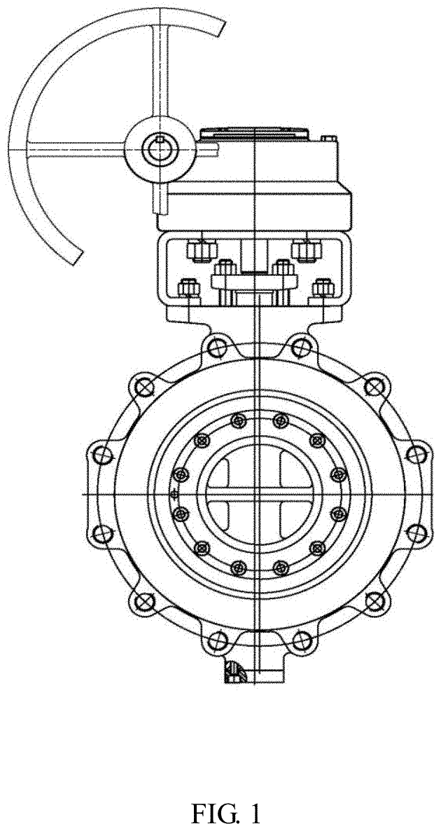

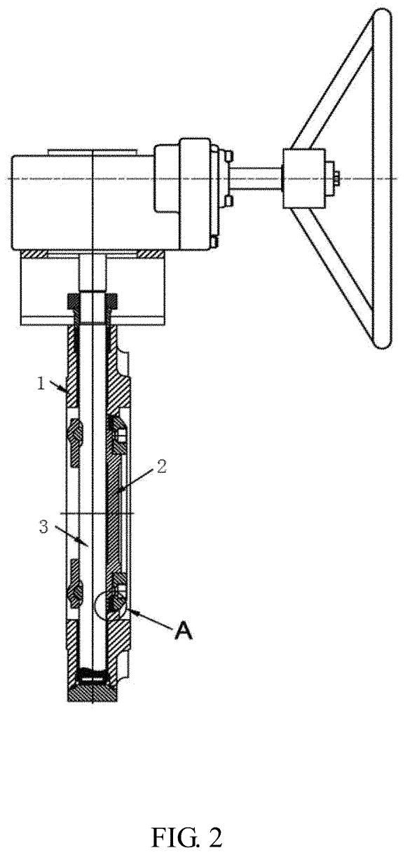

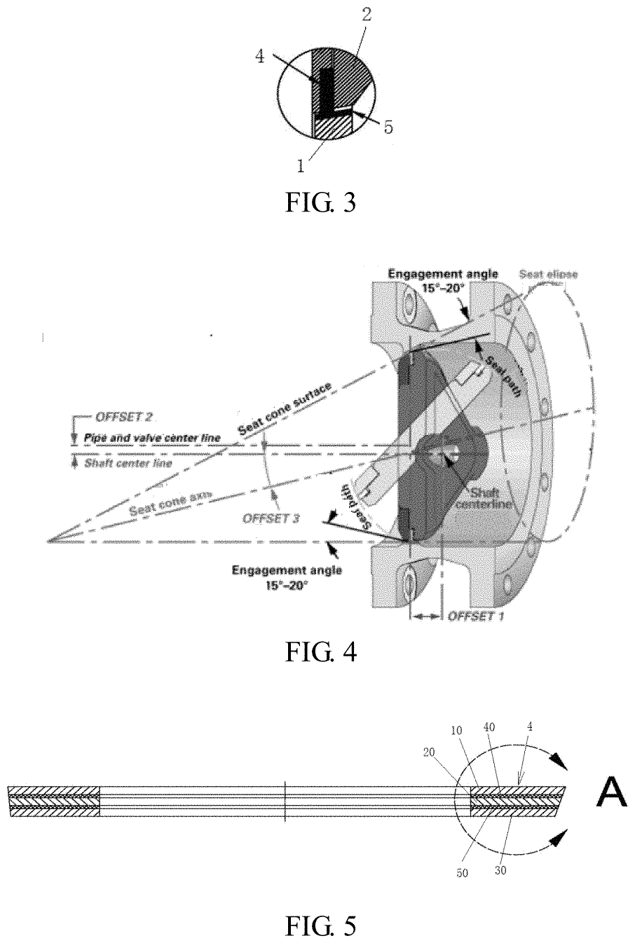

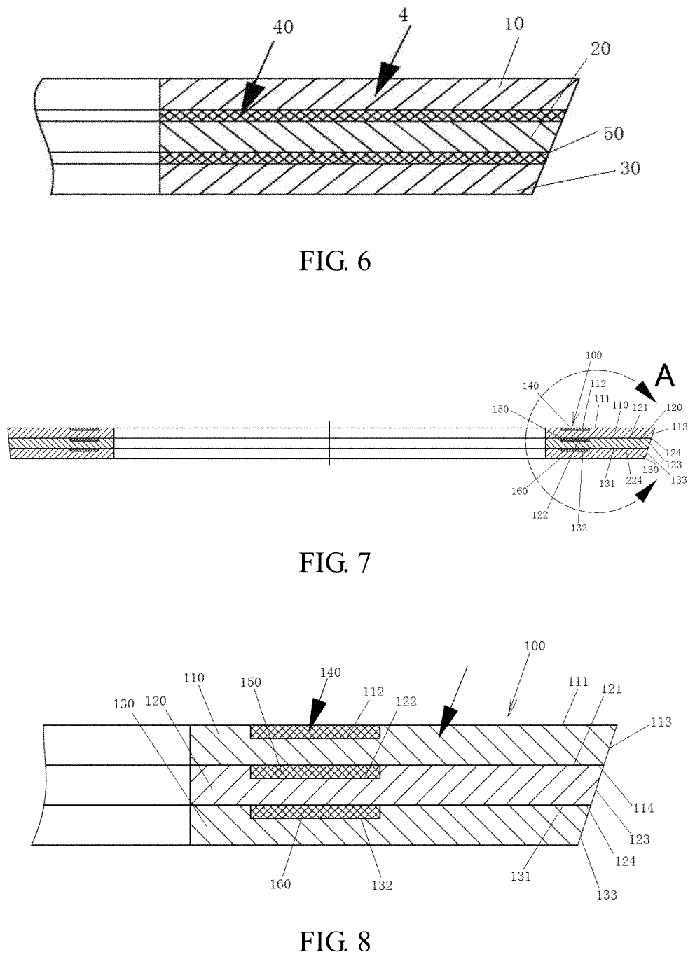

### DESCRIPTION OF THE EMBODIMENTS

The present invention is further described below in conjunction with the drawings and specific embodiments.

Referring to FIGS. 7 and 8, the sealing assembly 100 for a triple-eccentric metal hard sealing butterfly valve as shown in the figures comprises three metal sheets 110, 120, 130 and three sealing rings 140, 150. 160 made of a non-metallic auxiliary material. Of course, the number of metal sheets is not limited to three, and the number of sealing rings is not limited to three, which can be set according to the size of the butterfly valve.

One of the annular grooves 112, 122, 132 is provided on one surface 111, 121, 131 of the three metal sheets 110, 120, and 130. The annular grooves 112, 122, and 132 are provided on one side of the metal sheets 110, 120, and 130 away from the outer peripheral surfaces 113, 123, 133 of the metal sheet 110, 120, 130, respectively.

The three metal sheets 110, 120, 130 are superposed together in the axial direction of the metal sheets 110, 120, 130, and the surfaces 111, 121, 131 of the three metal sheets 110, 120, 130 are oriented uniformly.

The three sealing rings 140, 150, 160 are embedded in the annular grooves 112, 122, 132 of the three metal sheets 110, 120, 130, respectively. The outer surface of the sealing ring 160 is in sealing contact with the surface 124 of the metal sheet 120. The outer surface of the sealing ring 150 is in sealing contact with the surface 114 of the metal sheet 110. The outer surface of the sealing ring 140 is in contact with the valve or the valve body.

The outer peripheral surfaces 113, 123, 133 of the metal sheets 110, 120, 130 are processed into a slope to form a hard sealing surface of the sealing assembly 100. The non-metallic auxiliary materials from which the sealing rings 140, 150, 160 are made are graphite and graphite articles.

Compared with the prior art, the above sealing assembly 100 has the following beneficial effects.

1. The present invention adopts a new structure in which annular grooves 112, 122, 132 are processed on the three metal sheets 110, 120, 130 and the sealing rings 140, 150, 160 processed by the non-metal sealing auxiliary material are placed in the annular grooves 112, 122, 132. When the triple-eccentric butterfly valve is under the action of the opening and closing force, the friction between the three metal sheets 110, 120, 130 will be reduced, so that there is a slight amount of serial motion between the metal sheets 110, 120, 130, so that the hard sealing surface of the sealing assembly 100 is more likely to abut against the other hard sealing surface (the valve body sealing surface), thereby improving the sealing fit, truly forming a complete contact between metals for sealing, and making the sealing performance more reliable.

2. The present invention adopts a new structure in which annular grooves 112, 122, 132 are processed on the three metal sheets 110, 120, 130 and the sealing rings 140, 150, 160 processed by the non-metal sealing auxiliary material are placed in the annular grooves 112, 122, 132. When the valve position is opened, the medium in the pipeline will not wash the sealing ring 140, 150, 160 made of non-metallic auxiliary materials under the action of the flow rate, and will not make the non-metallic auxiliary materials fall off so as to directly affect the reliability of the sealing. A gap or a slit will not be formed in the hard sealing surface due to the non-metallic auxiliary materials falling off, so that it is easy for the impurities in the pipeline medium to fill the gap and the slit to cause damage to the sealing assembly 10, thereby improving the life.

3. The present invention improves the reliability of the sealing and is completely sealed by the metal. The application of the sealing assembly 100 enables the application range of the triple-eccentric butterfly valve to be extended to any medium, having high temperature, low temperature and severe working conditions, and extending the service life of the triple-eccentric sealing significantly.

An application embodiment of the above sealing assembly 100 is given below.

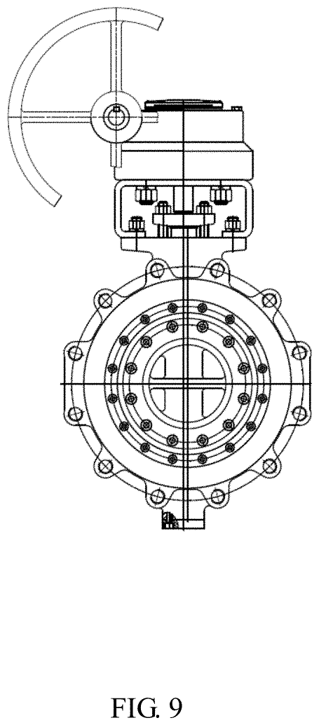

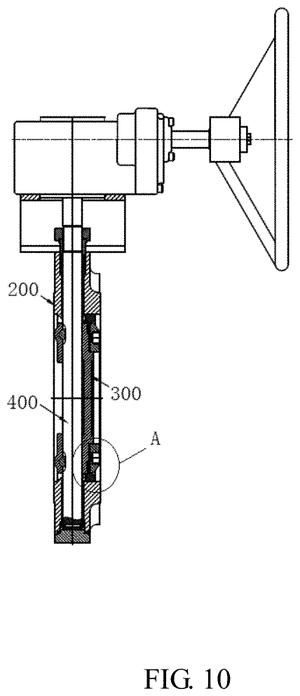

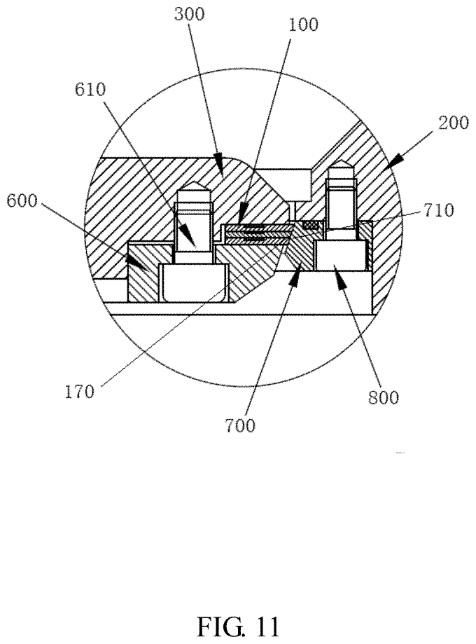

Referring to FIG. 9 to FIG. 11, there is shown a triple-eccentric hard sealing butterfly valve, which is mainly consisted of a valve body 200, a valve plate 300, a valve stein 400, and a sealing assembly 100.

After the valve plate 300 is enclosed into the through hole in the valve body 200, the valve stein 400 is inserted into the intermediate hole of the valve plate 300 and then coupled by a key or a pin.

The sealing assembly 100 is mounted on the valve plate 300 by a pressing plate 600 and a pressing plate bolt 610. A valve body-embedding sealing seat 700 is mounted on the valve body 200 by a valve body-embedding sealing seat bolt 800, and a hard sealing surface 710 is provided on the valve body-embedding sealing seat 700. The hard sealing surface 170 on the sealing assembly 100 is processed into an outer obliquely tapered surface, and the hard sealing surface 710 on the valve body-embedding sealing seat 700 is processed into an inner obliquely tapered surface.

Upon sealing, the hard sealing surface 170 on the sealing assembly 100 and the hard sealing surface 710 on the valve body-embedding sealing seat 700 achieve a hard sealing between the metals.

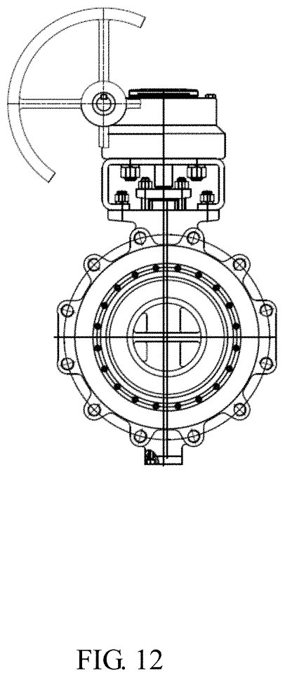

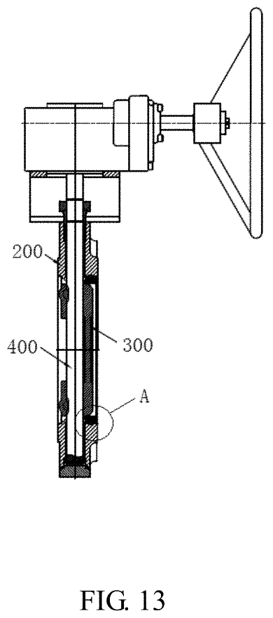

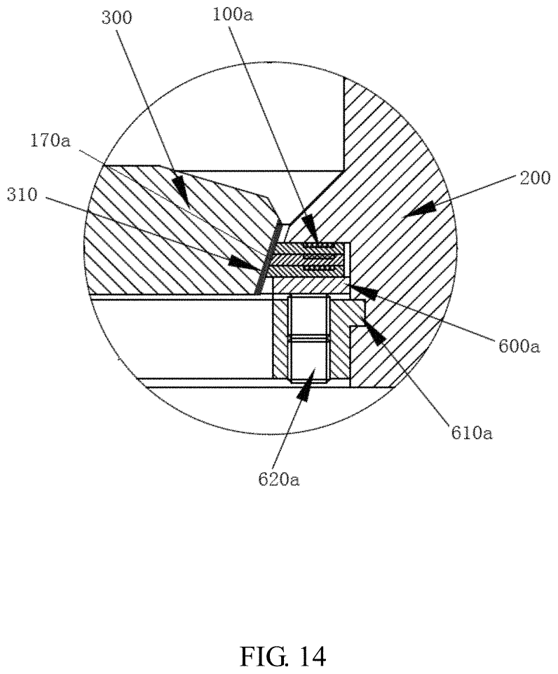

Referring to FIG. 12 to FIG. 14, there is shown another triple-eccentric hard sealing butterfly valve, which is mainly consisted of a valve body 200, a valve plate 300, a valve stein 400, and a sealing assembly 100a.

After the valve plate 300 is enclosed into the through hole in the valve body 200, the valve stein 400 is inserted into the intermediate hole of the valve plate 300 and then coupled by a key or a pin.

The sealing assembly 100a is mounted on the valve body 200 by a pressing plate 600a, a threaded pressing plate 610a, and a screw 620a, and a hard sealing surface 310 is bead welded on the valve plate 300.

The hard sealing surface 170a on the sealing assembly 100a is processed into an inner obliquely tapered surface, and the hard sealing surface 310 is processed into an inner obliquely tapered surface.

Upon sealing, the hard sealing surface 310 on the valve plate 300 and the hard sealing surface 170a on the sealing assembly 100a achieve a hard sealing between the metals.

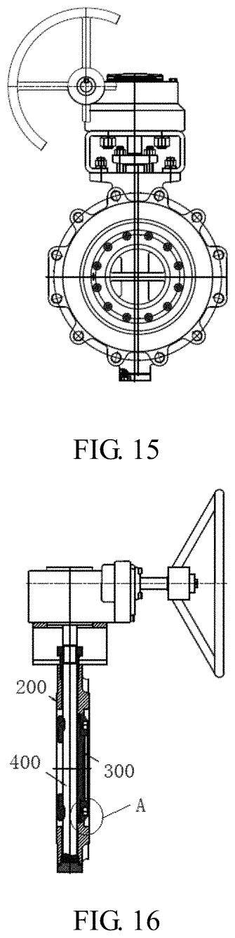

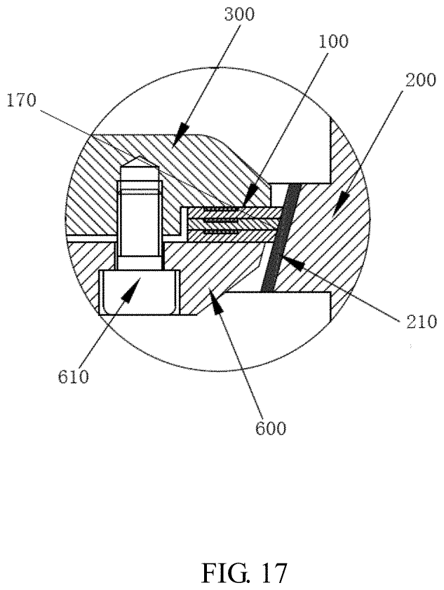

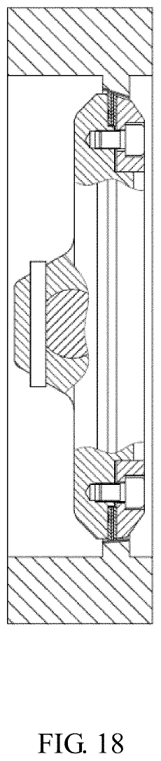

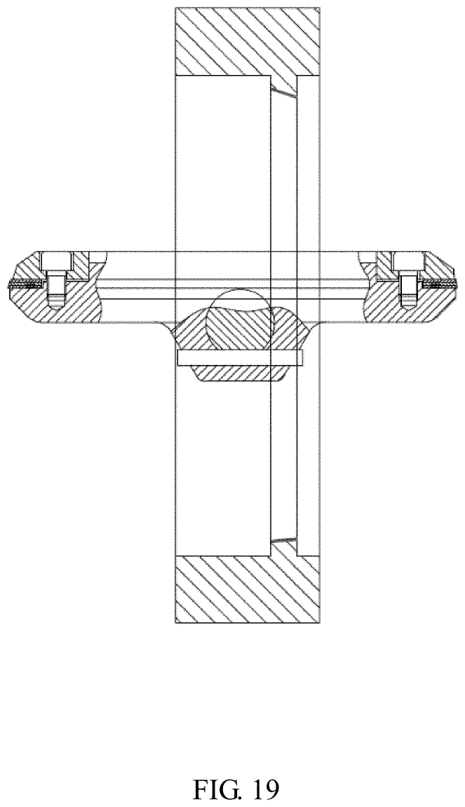

Referring to FIG. 15 to FIG. 17, there is shown still another triple-eccentric hard sealing butterfly valve, which is mainly consisted of a valve body 200, a valve plate 300, a valve stein 400, and a sealing assembly 100.

After the valve plate 300 is enclosed into the through hole in the valve body 200, the valve stein 400 is inserted into the intermediate hole of the valve plate 300 and then coupled by a key or a pin.

The sealing assembly 100 is mounted on the valve plate 300 by a pressing plate 600 and a pressing plate bolt 610, and a hard sealing surface 210 is bead welded on the sealing surface of the valve body 200. The hard sealing surface 170 on the sealing assembly 100 is processed into an outer obliquely tapered surface, and the hard sealing surface 210 is processed into an inner obliquely tapered surface.

Upon sealing, the hard sealing surface 170 on the sealing assembly 100 and the hard sealing surface 210 achieve a hard sealing between the metals.

The above triple-eccentric hard sealing butterfly valve is a double-clip-type triple-eccentric hard sealing butterfly valve, a flange-type triple-eccentric hard sealing butterfly valve, a boss-type triple-eccentric hard sealing butterfly valve, a lug-type triple-eccentric hard sealing butterfly valve or a welding-type triple-eccentric hard sealing butterfly valve.

What is claimed is:

1. A sealing assembly for a triple-eccentric metal hard sealing butterfly valve comprising at least two metal sheets and at least two sealing rings made of a non-metallic auxiliary material, wherein an annular groove is provided on one surface of each metal sheet, and each sealing ring is embedded in the corresponding annular groove.

2. The sealing assembly for a triple-eccentric metal hard sealing butterfly valve according to claim 1, wherein the metal sheets are superposed together in an axial direction of the metal sheets, and a sealing contact is formed between an outer surface of the sealing ring and the surface of the adjacent metal sheet on which an annular groove is not provided.

3. The sealing assembly for a triple-eccentric metal hard sealing butterfly valve according to claim 1, wherein the sealing groove is provided on a side of the metal sheet away from an outer peripheral surface of the metal sheet.

4. The sealing assembly for a triple-eccentric metal hard sealing butterfly valve according to claim 1, wherein the outer peripheral surface of the metal sheet is processed into a slope to form a hard sealing surface of the sealing assembly.

5. The sealing assembly for a triple-eccentric metal hard sealing butterfly valve according to claim 1, wherein the non-metallic auxiliary material is graphite.

6. A sealing structure comprising the sealing assembly of claim 1, further comprising another hard sealing surface that is sealed in cooperation with a hard sealing surface of the sealing assembly; wherein the sealing assembly is provided on a valve plate of the triple-eccentric butterfly valve, and the other hard sealing surface is provided on a valve body of the triple-eccentric butterfly valve.

7. The sealing structure according to claim 6, wherein the hard sealing surface is processed into an outer obliquely tapered surface and the other hard sealing surface is processed into an inner obliquely tapered surface.

8. The sealing structure according to claim 6, further comprising another hard sealing surface that is sealed in cooperation with a hard sealing surface of the sealing assembly; wherein the sealing assembly is provided on the valve body of the triple-eccentric butterfly valve, and the other hard sealing surface is provided on the valve plate of the triple-eccentric butterfly valve.

9. The sealing structure according to claim 7, wherein the hard sealing surface is processed into an inner obliquely tapered surface and the other hard sealing surface is processed into an outer obliquely tapered surface.

10. The sealing structure according to claim 6, comprising the above two sets of sealing assemblies, wherein one set of sealing assemblies is provided on the valve body of the triple-eccentric butterfly valve, and the other set of sealing assemblies is provided on the valve plate of the triple-eccentric butterfly valve; the hard sealing surfaces of the two sets of seal assemblies are in sealing contact.

11. The sealing structure according to claim 10, wherein the hard sealing surface provided in the sealing assembly on the valve plate of the triple-eccentric butterfly valve is processed into an outer obliquely tapered surface, and the hard sealing surface provided in the sealing assembly on the valve body of the triple-eccentric butterfly valve is processed into an inner obliquely tapered surface.

12. A triple-eccentric hard sealing butterfly valve comprising the sealing structure according to claims 6.

13. The triple-eccentric hard sealing butterfly valve according to claim 12, wherein the triple-eccentric hard sealing butterfly valve is a double-clip-type triple-eccentric hard sealing butterfly valve, a flange-type triple-eccentric hard sealing butterfly valve, a boss-type triple-eccentric hard sealing butterfly valve, a lug-type triple-eccentric hard sealing butterfly valve or a welding-type triple-eccentric hard sealing butterfly valve.
